(19) United States
(12) Patent Application Publication
(10) Pub. No.: US 2026/0141021 A1
(43) Pub. Date: May 21, 2026

(54) GENERATING SEGMENTED TENSOR PRODUCTS USING GRAPHICS PROCESSING UNITS

(71) Applicant: NVIDIA Corporation, Santa Clara, CA (US)

(72) Inventors: Mario GEIGER, Lausanne (CH); Han-Yi CHOU, Cupertino, CA (US); Maximilian STADLER, Munich (DE); Markus HOEHNERBACH, Santa Clara, CA (US); Dejun LIN, Lynnwood, WA (US)

(73) Assignee: NVIDIA Corporation, Santa Clara, CA (US)

(21) Appl. No.: 18/949,435

(22) Filed: Nov. 15, 2024

(51) Int. Cl. G06F 17/16; G06F 9/50

(52) U.S. Cl. CPC G06F 17/16; G06F 9/5016

(57) ABSTRACT

In various examples, systems and methods are disclosed relating to generating segmented tensor products using graphics processing units. One or more circuits can identify a plurality of operands for a tensor operation. Each operand divided into a set of segments each including at least a portion of the operand. The one or more circuits can identify a plurality of paths for the tensor operation, each path identifying a set of coefficients and at least one segment of each operand of the plurality of operands. The one or more circuits can generate a respective partial output for each path of the plurality of paths according to the tensor operation, the at least one segment of the path, and the set of coefficients of the path. The one or more circuits can generate an output tensor for the tensor operation based at least on the respective partial output for each of the plurality of paths.

### BACKGROUND

Graphics processing units (GPUs) perform tensor operations by leveraging their highly parallel architecture to execute multiple computations simultaneously. However, calculating tensor products using GPUs as accelerators is challenging due to the complexities surrounding memory bandwidth and memory access for GPUs.

### SUMMARY

Tensor multiplication is a fundamental mathematical operation with applications in physics, graphics calculations, and machine learning. Conventional approaches to generating tensor products often lack specific acceleration techniques for calculating equivariant tensor products and include numerous sub-operations that fail to eliminate non-zero coefficients efficiently. These inefficiencies increase processing time and computational complexity, thereby limiting the practicality of these methods in real-time or high-performance computing environments.

To address these limitations, the systems and methods described herein introduce segmented tensor product calculations. By subdividing each operand of a tensor operation into corresponding segments, which are portions used for specific parts of the output calculation, these techniques ensure relevant data is processed in parallel. Each segment can have a defined shape and dimensionality, allowing parallel processing to be utilized effectively across multiple computational paths independently. Additionally, specialized kernels can automatically select optimized routines based on tensor dimensions or shared operands among batches, further enhancing computational efficiency. These improvements facilitate faster computation times while reducing memory access events through caching redundant segments and leveraging tiling techniques for better cache utilization in parallel architectures like GPUs.

At least one aspect relates to one or more processors. The one or more processors can include one or more processing circuits. The one or more processing circuits can identify a plurality of operands for a tensor operation, and each operand of the plurality of operands is associated with a set of segments. The one or more processing circuits can identify a plurality of paths for the tensor operation, each path identifying a set of coefficients and a segment of each operand of the plurality of operands. The one or more processing circuits can generate a respective partial output for each path of the plurality of paths according to segments of the path and/or the set of coefficients of the path. The one or more processing circuits can generate an output tensor for the tensor operation based at least on the respective partial output for each path of the plurality of paths.

In some implementations, the plurality of operands is associated with a set of subscripts corresponding to a dimensionality of the set of segments. In some implementations, the one or more processing circuits can determine the tensor operation from a string identifying the set of subscripts. In some implementations, the one or more processing circuits can allocate a portion of cache memory of the one or more processing circuits to store one or more segments identified by at least two paths of the plurality of paths. In some implementations, the one or more processing circuits can generate a first partial output for a first path of the plurality of paths using a first processing kernel. In some implementations, the one or more processing circuits can generate a second partial output for a second path of the plurality of paths using a second processing kernel.

In some implementations, the one or more processing circuits can select the first processing kernel based at least on one or more of a number of the plurality of operands or a dimensionality of at least one segment identified by the first path. In some implementations, the one or more processing circuits can generate the set of segments for the plurality of operands, wherein the set of segments comprise a common shape. In some implementations, the one or more processing circuits can identify a subset of the set of coefficients that has non-zero values. In some implementations, the one or more processing circuits can generate the respective partial output for the plurality of paths based at least on the subset.

At least one aspect relates to a system. The system can include one or more processors. The system can receive a set of segments associated with a plurality of processing paths for a tensor operation. The system can select, based at least on the tensor operation, a first kernel for processing a first processing path of the plurality of processing paths and a second kernel for processing a second processing path of the plurality of processing paths. The system can generate a set of output segments by executing the first kernel according to the first processing path and the second kernel according to the second processing path.

In some implementations, the system can generate the set of output segments further based on a first set of coefficients of the first processing path and a second set of coefficients of the second processing path. In some implementations, the system can cache at least a portion of the set of segments in a shared memory. In some implementations, the tensor operation is an equivariant tensor operation. In some implementations, the system can cache a first segment of the set of segments that is identified in both the first processing path and the second processing path. In some implementations, the system can generate the set of output segments by accessing the shared memory using the first kernel and the second kernel. In some implementations, the system can select the first kernel or the second kernel further based on dimensions of the set of segments. In some implementations, the system can select the first kernel or the second kernel further based on a number of operands for the tensor operation.

At least one aspect is related to a method. The method can include identifying a plurality of operands and a plurality of sets of segments for a tensor operation, and each set of the plurality of sets of segments corresponds with an operand of the plurality of operands. The method can include identifying a plurality of paths each identifying a set of coefficients and a segment from each set of the plurality of sets of segments. The method can include selecting a plurality of kernels based on one or more of the plurality of operands or the plurality of sets of segments. The method can include executing the plurality of kernels to generate an output tensor for the tensor operation.

In some implementations, the plurality of operands is associated with a set of subscripts corresponding to a dimensionality of the set of segments. In some implementations, the method can include determining the tensor operation from a string identifying the set of subscripts. In some implementations, the method can include allocating a portion of cache memory to store one or more segments identified by at least two paths of the plurality of paths.

The processors, systems, and/or methods described herein can be implemented by or included in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system for performing generative AI operations using a large language model, a system for performing generative AI operations using a small language model, a system for performing generative AI operations using a video language model, a system implemented using an edge device, a system implemented using a robot, a system for performing conversational AI operations, a system for presenting at least one of virtual reality content, augmented reality content, or mixed reality content, a system for generating synthetic data, a system incorporating one or more virtual machines (VMs), a system implemented at least partially in a data center, or a system implemented at least partially using cloud computing resources.

### BRIEF DESCRIPTION OF THE DRAWINGS

The present systems and methods for generating segmented tensor products using graphics processing units are described in detail below with reference to the attached drawing figures, wherein:

FIG. 1 is a block diagram of an example system for generating segmented tensor products using graphics processing units, in accordance with some embodiments of the present disclosure;

FIG. 2 depicts an example diagram showing an example diagram indicating computational paths for a segmented tensor product, in accordance with some embodiments of the present disclosure;

FIG. 3 is a flow diagram of an example of a method for generating segmented tensor products using graphics processing units, in accordance with some embodiments of the present disclosure;

FIG. 4 is a block diagram of an example computing device suitable for use in implementing some embodiments of the present disclosure; and

FIG. 5 is a block diagram of an example data center suitable for use in implementing some embodiments of the present disclosure.

### DETAILED DESCRIPTION

This disclosure relates to systems and methods for utilizing parallel processing techniques to calculate segmented tensor products. Tensor multiplication is a fundamental operation in mathematics that is used for a variety of applications, including but not limited to physics calculations, graphics calculations, and machine-learning operations. Conventional approaches for generating tensor products lack specific acceleration techniques for calculating equivariant tensor products and often include numerous sub-operations that fail to eliminate non-zero coefficients, thereby increasing processing time and complexity.

To address these limitations, the systems and methods described herein provide techniques for calculating segmented tensor products. A segmented tensor product can define a multilinear operation of arbitrary number of operands. To calculate a segmented tensor product, each operand can be subdivided into corresponding segments, which represent a portion of the tensor that may be used in calculating a particular portion of an output of the segmented tensor product. The segments that each operand is divided among can be contiguous segments, with each segment having a specific shape and/or dimensionality corresponding to the particular operand.

The number of dimensions of the segments may be same for all segments within the operand. Each operand can be associated with a set of subscripts. Each subscript of an operand can be referred to as a “mode,” where the number of modes (or subscripts) of an operand can identify the number of dimensions of each segment of the operand. Each mode can appear in at most once in each operand's subscripts. The number of subscripts of each operand, as well as the subscripts themselves can be specified prior to performing the segmented tensor product calculation.

The calculation of a segmented tensor product can be performed using one or more paths, which can include instructions to select specific segments from each operand to perform a portion of the segmented tensor product calculation. In some implementations, each path can be independent, such that each path can be calculated in parallel with other paths of the segmented tensor product. The paths can be specified or otherwise defined such that each path selects one segment from each operand. Each path can include a set of coefficients, which themselves may be multidimensional tensor data structures.

The segmented tensor product can be defined as a multilinear combination of the selected segments from each operand weighted by the coefficients of the corresponding path. The compatibility of the segments and the coefficients of each path can be ensured by the shared modes and the subscripts of each operand. To calculate a segmented tensor product, one of the operands can be selected as an output operand and the other operands may be selected as input operands. Each path is then calculated (e.g., using parallel computing operations, etc.) and accumulated into the segments of the output operand.

Various parallel processing techniques can be used to improve computational performance of calculating segmented tensor products. In one example, the techniques described herein can implement flattening of path coefficients to retain only non-zero coefficients. In some implementations, segments can be split into smaller portions having uniform shapes that facilitate improved memory access performance. Additionally, in some implementations, memory caching can be implemented to reduce redundant calculations and memory access events.

For example, paths resulting from equivariant tensor operations may be redundant, with segments occurring in more than one path. This redundancy can be leveraged using caching in memory, including shared memory using in parallel processing architectures such as graphical processing units (GPUs). The techniques described herein can implement tiling to subdivide segment dimensions that exceed the capacity of cache memory, such that portions of the operands that are redundant can be efficiently cached and processed.

In some implementations, specialized processing kernels can be implemented to process particular use cases of segmented tensor operations. For example, specialized kernels can be automatically selected and executed for tensors having particular dimensions (e.g., uniform dimensions across all segments), numbers of operands, repeat input buffers/operands, or shared operands among batches or subsets of batches. Kernels can be automatically selected/dispatched according to these different cases to improve computational efficiency of segmented tensor operations.

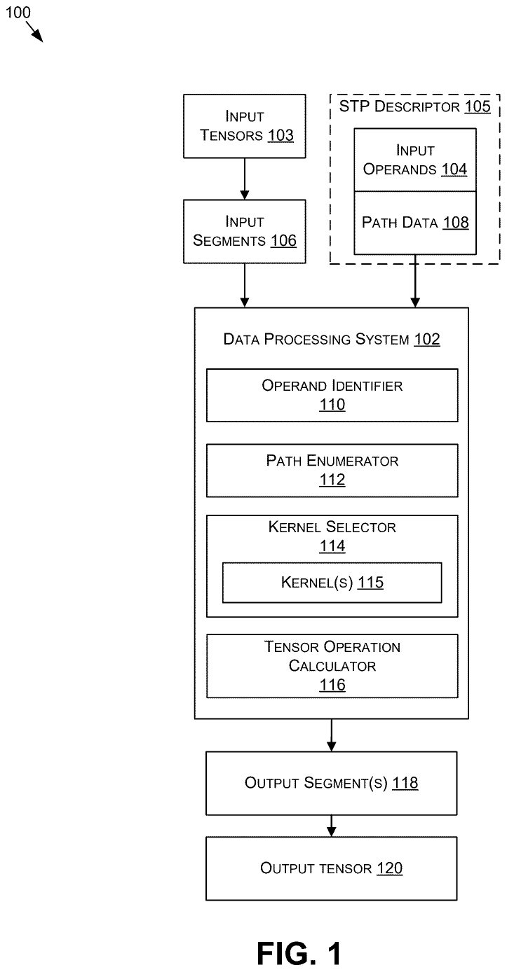

With reference to FIG. 1, FIG. 1 is an example computing environment including a system 100 for generating segmented tensor products using graphics processing units, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The system 100 is shown as including a data processing system 102, which can process one or more input tensors 103 to generate an output tensor 120 according to a segmented tensor operation (STP). An STP descriptor 105 for the tensor operation can specify one or more input operands 104 and corresponding path data 108. The input operands 104 can be divided into or otherwise associated with one or more corresponding input segments 106 that are to be processed by the data processing system 102 according to the path data 108. To generate one or more output tensors 120, the data processing system 102 can perform the various techniques described herein to process the input segments 106 according to processing paths specified via the path data 108 to generate one or more output segments 118.

The data processing system 102 can execute an operand identifier 110 to identify/receive operands for a tensor operation and/or the input segments 106 thereof. The data processing system 102 can execute a path enumerator 112 to enumerate/identify processing paths specified in the path data 108 corresponding to the input segments 106, which can be used to generate and/or accumulate one or more of the output segments 118. The data processing system 102 may execute a kernel selector 114 to dispatch/enqueue/configure/select one or more kernels 115 that can be used to process the identified processing paths. The data processing system is shown as including a tensor operation calculator 116 that performs the calculations to carry out a requested tensor operation, which may be an equivariant tensor operation or another type of tensor operation.

The data processing system 102 can be or include any type of device that is capable performing mathematical calculations, including but not limited to a distributed computing system, one or more servers in communication with one or more client devices, a personal computing device, or any other type of processing device. The data processing system 102 may include any type of non-transitory memory to store various data described herein, including but not limited to the input operands 104, the input segments 106, the path data 108, intermediate results of various calculations, cache memory (e.g., shared cache memory that may be accessed by multiple processing devices, etc.), the output segments 118, and/or the output tensors 120, among other data. The data processing system 102 can include any number of processing elements/devices, including but not limited to central processing units (CPUs), GPUs, field-programmable gate arrays (FPGAs), and/or application-specific integrated circuits (ASICs), among others.

The system 100 is shown as including one or more input operands 104. The input operands 104 can be provided/specified/identified for a tensor operation. The input operands 104 can include structured data elements that serve as the inputs to generate one or more output tensors 120 by performing various mathematical operations corresponding to the tensor operation. In some implementations, each input operand 104 can be represented as a data structure having one or more many dimensions. The dimensions can define the shape of the tensor of the input operand 104.

In some implementations, the data processing system 102 receives input operands 104 that can be provided from an application executing on the data processing system 102, or from another computing device in communication with the data processing system 102. The structure and content of the input operands 104 can be based on their intended use in different applications such as physics calculations, graphics rendering, or machine learning tasks. For example, each tensor operand might represent physical quantities with specific dimensions (e.g., spatial coordinates) that are used to in physical simulations computations. The data processing system 102 can identify the input operands 104 using various any suitable operation, which may include the use of one or more libraries or application programming interfaces (APIs) implemented at the data processing system 102.

The system 100 is shown as including one or more input segments 106, which can result from dividing the input tensors 103 for the tensor operation. Each input tensor 103 can be subdivided into corresponding input segments 106 to facilitate efficient and parallel processing of the tensor operation. Each input segment 106 can be stored as a contiguous data structure in memory of the data processing system 102, to improve memory access performance when processing the corresponding segment 106, as described herein. Different segments 106 may correspond to different input operands 104 for the tensor operation. The segments 106 generated for the tensor operation can be stored in association with an identifier of the operand to which the segments 106 correspond. In some implementations, data for an input operand 104 data in the STP descriptor 105 can specify the set of segments 106 corresponding to that input operand 104.

Each input operand 104 and the input segments 106 associated therewith can correspond to a set of subscripts, which are sometimes referred to herein as “modes.” The number of subscripts for a given input operand 104 can define the dimensions of each input segment 106 of that operand. For example, if an input operand 104 has subscripts “u” and “v,” the input segments 106 generated/derived from that input operand 104 can include two-dimensional data structures (e.g., two-dimensional tensors). In some implementations, the subscripts of the operands can be extracted from one or more text strings specified in corresponding path data 108, as described herein.

The input tensors 103 can be subdivided into one or multiple input segments 106 based at least on the tensor operation intended to be performed. Input segments 106, and the processing paths corresponding thereto, can be specified as part of the one or more tensor operations involving the input tensors 103. For example, an operator of the data processing system 102 can configure the input tensors 103 to each be subdivided into a corresponding set of inputs segments 106 to facilitate accelerated processing of the tensor operation. The process of subdividing different input tensors 103 into input segments 106 can be application and/or operation specific.

In some implementations, one or more input segments 106 and/or input tensors 103 can undergo transposition operations before being processed. Transposing a segment 106 and/or input tensor 103 can involve rearranging its dimensions to align with the requirements of specific tensor operations and/or processing paths specified in the path data 108. For example, if a tensor operation can be accelerated by providing one dimension as rows and another dimension as columns, the corresponding input segment 106 and/or input tensor 103 can be transposed accordingly. Transposing input tensors 103 and/or input segments can facilitate compatibility with other input tensors 103 and can accelerate processing of certain tensor operations according to the processing paths specified in the path data 108.

The STP descriptor 105 is shown as including path data 108, which can be generated to process the input segments 106 derived from the input tensors 103. The path data 108 specifies one or more processing paths that define how individual input segments 106 are combined and/or processed during a tensor operation. Each processing path can include or otherwise indicate instructions to efficiently calculate specific portions of the output segments 118 and/or the output tensor 120. The processing paths of the path data 108 can be specified as part of the one or more tensor operations involving the input operands 104. For example, an operator of the data processing system 102 can generate/configure the path data 108 to indicate different processing paths that identify respective input segments 106 and output segments 118 to facilitate accelerated processing of the tensor operation. The process of creating processing paths in the path data 108 to process the input segments 106 can be application and/or operation specific.

In some implementations, the path data 108 can specify each processing path using text strings identifying subscripts associated with the operands 104. The text strings can provide instructions on which input segments 106 are selected for a given processing path and/or how the input segments 106 can be combined/processed to compute one or more corresponding specified output segments 118. For example, if an operand has subscripts “u” and “v,” the path data 108 might specify that one particular processing path involves selecting segments 106 corresponding to subscript pairs “u” and “v.” Each processing path can itself specify a tensor operation, which can be a sub-operation of the tensor operation to be performed for the input operands 104.

One example of an operation that may be specified in the processing path of the path data 108 can be a tensor multiplication operation. The tensor multiplication operation can specify which input segments 106 are to be multiplied as part of the tensor operation and the output segment 118 where the outputs are to be accumulated. In some implementations, the tensor operation to be accelerated using the processing paths specified in the path data 108 may be a coefficient-modified tensor operation, such as a weighted tensor multiplication operation. In such implementations, the path data 108 can specify, for a given processing path, a corresponding set of coefficients that are to be applied to one or more input segments 106 when calculating the portion of the coefficient-modified tensor product.

In one example, the coefficients can serve as weight values that are applied to the tensors during the operation. In some implementations, the processing path can specify the coefficients as a corresponding tensor that is to be applied to one or more of the input segments 106 to be processed according to the techniques described herein. In an example processing path, the coefficients can be applied by multiplying the elements of the tensors of the input segments 106 by the elements of the coefficient tensors before performing a multiplication operation between the input segments 106, to calculate a weighted tensor product between the input segments 106.

The data processing system 102 can execute the operand identifier 110 to identify one or more input operands 104 and/or input segments 106 that correspond thereto for a tensor operation. The operand identifier 110 can include hardware, software, or any combination thereof. The operand identifier 110 can identify/receive/store input operands 104 and corresponding input segments 106 using any suitable technique. In one example, the operand identifier 110 can receive tensors from an application or script executing at the data processing system 102 that specifies the tensors as being part of one or more input segments 106 of one or more input operands 104. In some implementations, the operand identifier 110 can retrieve pre-stored or cached data structures representing the memory locations designated by an API call made to the data processing system 102.

In some implementations, one or more input segments 106 of one or more input operands 104 can be generated dynamically using operator-defined parameters/values provided through a library interface. In such implementations, the library interface (which may include an API, one or more library functions, etc.) can be used to receive data specifying different data elements, dimensions/shape information, operand and segment identifiers, or any other attribute of one or more input segments 106 of one or more input operands 104. The operand identifier 110, using the data received from the interface, can automatically generate/store the information in contiguous regions of memory in the data processing system 102 according to the specified parameters.

The operand identifier 110 can store each input segment 106 of one or more input operands 104 in a designated region in memory. In some implementations, the operand identifier 110 can assign/store/identify metadata in association with each segment 106, such as a segment identifier. The segment identifier can be used and/or referenced in one or more processing paths of the path data 108 during subsequent processing stages. In some implementations, the operand identifier 110 can allocate a data structure for each input operand 104 that specifies a list of identifiers for the input segments 106 derived from the corresponding input operand 104. In some implementations, the operand identifier 110 can identify one or more input segments 106 of corresponding input operands 104, and/or metadata thereof, from the path data 108. For example, the path data 108 may specify the shape/dimensions, subscripts, and operand association for each input segment 106. In some implementations, the path data 108 may specify or otherwise provide identifiers for one or more input segments 106 and/or corresponding operands 104.

In some implementations, the operand identifier 110 can perform error checking to ensure that the input operands 104 and/or the input segments 106 are compatible with the segmented tensor processing techniques described herein. For example, the operand identifier 110 can iterate through each of the input operands 104 to ensure that each subscript for the tensor operation appears in at least two operands. In another example, the operand identifier 110 can iterate through each of the input segments 106 to verify that the shape of each tensor in the input segments 106 corresponds to the number of subscripts of the corresponding input operand 104. If an error is detected (e.g., inconsistent dimensions or subscripts, etc.), the operand identifier 110 can provide an error message identifying the error and can cease processing of the segmented tensor operation.

The data processing system 102 can execute the path enumerator 112 to enumerate/identify each of the processing paths specified in the path data 108. The path enumerator 112 can include hardware, software, or any combination thereof. Enumerating/identifying the processing paths in the path data 108 can include parsing or otherwise interpreting the information provided as part of the path data 108, which can include identifying/extracting operations, identifiers of input segments 106, identifiers of output segments 118, and any associated coefficients for each processing path. The data processing system 102 can execute the path enumerator 112, in one example, upon receiving or otherwise identifying a request to execute a tensor operation involving one or more input operands 104.

In some implementations, the path enumerator 112 can enumerate/identify the operations to be performed on specific input segments 106 by parsing text strings within the path data 108. These text strings specify subscripts of operands that define which input segments are involved in a given operation and how they should be combined or processed. For example, if an input segment 106 for an input operand 104 corresponds to subscripts “u” and “v,” the path enumerator 112 can parse the text string according to the subscripts “u” and “v” to identify the tensor operation to be performed involving the input segment 106. In some implementations, the path enumerator 112 can parse instructions in the path data 108 to generate a text string for the tensor operation involving a set of input segments 106. For example, the path enumerator 112 can identify the tensor operation to be performed involving one or more input segments 106 and can automatically generate a text string/instruction that includes the subscripts corresponding to the one or more input segments 106. The text string/instructions can be used in connection with a tensor operation function, such as an “einsum” function, in one example. In this example, the text string/instructions can conform to a format compatible with the “einsum” function.

The path enumerator 112 can allocate one or more regions of memory within the data processing system 102 to store output segments 118 generated by each processing path. For example, if a particular processing path involves multiplying two input segments 106, the resulting product can be stored and/or accumulated in an output segment 118, which itself can be a tensor and/or portion of an output operand having its own set of subscripts, as described herein. Allocating regions of memory for the output segments 118 may include accessing subscript information for the output segments in the path data 108, and automatically assigning the subscripts to the output segments 118 as identifiers/metadata. In some implementations, the path enumerator 112 can generate and/or associate an identifier to each of the output segments 118, which may also be specified or referenced in the path data 108.

In some implementations, each processing path in the path data 108 can include coefficients for tensor operations. The path enumerator 112 can identify and/or store the coefficients in memory of the data processing system 102 in association with identifiers of the input segments 106 and output segments 118 for each corresponding processing path. As described herein, the coefficients can be used to weight or modify tensors during operations involving different segments 106. In some implementations, the path enumerator 112 can store each set of coefficients for each processing path in a respective contiguous region of memory.

In some implementations, the path enumerator 112 can apply one or more transformations to the coefficients to improve processing efficiency of the tensor operation. In one example, the path enumerator 112 can flatten the coefficient tensors by removing calculations of a processing path involving a zero-valued coefficient. In certain circumstances, coefficient values in a coefficient tensor may be zero, and therefore any value to which the coefficient is applied would also result in a value of zero. In such circumstances, the path enumerator 112 can automatically identify the processing paths involving zero-valued coefficients and automatically generate/provide an indication that the corresponding calculation involving that coefficient is equal to zero. This results in each processing path identifying calculations that have non-zero coefficient values, which can significantly increase computational performance when a coefficient tensor has many zero-valued elements.

The data processing system 102 can execute the kernel selector 114 to select one or more processing kernels 115 for executing the identified processing paths specified in the path data 108. The kernel selector 114 can include hardware, software, or any combination thereof. The kernel selector 114 can select one or more processing kernels 115 to optimize computational efficiency by selecting kernels 115 that are specialized for specific characteristics of different tensor operations. For example, different processing paths specified in the path data 108 can indicate different tensor operations and/or may operate using input segments 106 having attributes (e.g., relating to dimensions, shape, etc.). To improve computational efficiency of calculating the tensor operation involving the input operands 104.

The kernels 115 can be any type of software routines or functions that include instructions to perform specific tensor operations efficiently, for example, on distributed computing hardware such as GPUs. In some implementations, one or more kernels 115 may include instructions to perform general tensor operations given input tensor (e.g., input segments 106), such as tensor multiplication, element-wise tensor operations, or any other type of tensor operation. In some implementations, kernels 115 may include instructions that are tailored for characteristics of the input operands and segments, such as uniform dimensions across all segments, particular numbers of operands involved in an operation, or kernels 115 that leverage particular regions of cache memory to perform computations, among others.

In some implementations, one or more kernels 115 may include instructions to implement particular memory access patterns to improve the efficiency of different tensor operations. In one example, one or more processing kernels 115 can include instructions to “tile” portions of input segments 106 that exceed the size of cache memory of one or more processing elements of the data processing system (e.g., one or more GPUs). Tiling can include dividing a segment 106 that is to be processed by the kernel 115 into “tiles,” or contiguous portions, along one or more dimensions that exceed a size of memory of the data processing system (e.g., cache memory, etc.). The size of the tiles can be selected according to the size of the cache memory of processing elements of the data processing system 102.

In some implementations, the kernel selector 114 selects one or more specialized kernels 115 for a given processing path based on various attributes such as the number of subscripts associated with the input segments 106 involved in an input, uniform dimensions across all segments, number of operands involved in the operation, repeat input buffers/operands, and whether operands are shared among batches or subsets of batches. For example, if an operand has consistent dimensions (e.g., a tensor where each segment is uniformly shaped), specialized kernels optimized for such tensors can be selected to improve computational efficiency.

In some implementations, when multiple processing paths identified in the path data 108 involve input segments 106 having similar characteristics across all operands, the kernel selector 114 may select a single kernel 115 compiled/generated to efficiently process tensors having these common characteristics. The selected kernel 115 can then be used to process the multiple processing paths. In some implementations, the kernel selector 114 can select one or more processing kernels 115 that access and/or allocate/populate shared regions of memory to store repeat input buffers or shared operands 104/segments 106 among batches/subsets of batches of tensor operations. The selected specialized kernel(s) 115 to can include instructions that efficiently process calculations using the shared cache memory.

The kernel selector 114 operates as a dispatch mechanism that configures/enqueues the execution of each selected kernel 115 for processing individual paths specified in the path data 108. Selecting kernels 115 can involves identifying specific attributes from the input operands 104, such as their dimensions and subscripts, to match them with appropriate kernels designed to handle those characteristics efficiently. Once a suitable kernel is identified by the kernel selector 114 according to the characteristics of the tensor operation(s) to be performed, the kernel selector 114 can configure/enqueue the selected kernel(s) 115 for execution. Configuring the selected kernels 115 can involve initializing/populating/generating parameters such as memory addresses, segment identifiers, and coefficients associated with each processing path in memory of one or more processing elements.

The data processing system 102 can execute the tensor operation calculator 116 to carry out the tensor operation by executing each of the processing paths identified by the path enumerator 112. The tensor operation calculator 116 can include hardware, software, or any combination thereof. To do so, the tensor operation calculator 116 can iterate through each processing path to execute the corresponding processing operations associated with that processing path. For example, the tensor operation calculator 116 can access the allocated regions of memory that store the corresponding output segment(s) 118, input segments 106, and any associated coefficients to perform the various tensor operations. The tensor operation calculator 116 can access the regions of memory using the identifiers of the input segments 106, output segments 118, and associated coefficients generated/assigned to the components of the tensor operation.

In one example implementation, the tensor operation calculator 116 accumulates results of an “einsum” operation/function using a text string corresponding to the specific processing path being calculated. The einsum function can be used to perform various types of tensor operations, including but not limited to tensor multiplication operations, tensor contraction operations, or other operations using specified subscripts. For instance, if a given processing path involves multiplying two input segments 106 with respective subscripts “u” and “v,” and storing the resulting product in an output segment 118 identified by the subscript “w,” an example text string can be accessed/generated to perform that operation (e.g., “u, v−>w”). The tensor operation calculator 116 then uses this text string to compute the result of the einsum operation and store it into a designated output segment.

In some implementations, the tensor operation calculator 116 can accumulate the result of the processing path in the corresponding output segment 118. This enables the tensor operation calculator 116 to calculate an output segment 118 using multiple processing paths, each of which may generate partial results for the output segment 118. Accumulating the results in the output segment 118 can include adding each partial result generated via the corresponding processing paths to the stored value of the output segment 118. The tensor operation calculator 116 can iterate through, and can execute operations of, each of the processing paths specified in the path data 108 to generate a set of output segments 118 for the tensor operation.

In some implementations, in performing the operations corresponding to each processing path, the tensor operation calculator 116 can invoke one or more kernels 115 selected by the kernel selector 114. For example, the tensor operation calculator 116 can, when executing one or more einsum functions, automatically access one or more processing kernels 115 using corresponding APIs or function calls to carry out the operations for the einsum function. In some implementations, the tensor operation calculator 116 and/or the kernel selector 114 can configure each selected kernel 115 with parameters such as memory addresses and/or identifiers corresponding to input segments 106 involved in each corresponding processing path, along with any associated coefficients if applicable. For example, a specialized kernel optimized for tensor multiplication involving uniformly shaped tensors can be invoked when a processing path indicates input segments 106 having uniform dimensions. Invoking processing kernels 115 can include executing/providing instructions for each kernel 115 to process its respective input segments 106 according to specified processing operations of the processing path.

The tensor operation calculator 116 can iterate through each processing path until all processing paths have been processed, resulting in a set of output segments 118 that can store the result of the tensor operation for the input operands 104. Once calculated, the tensor operation calculator 116 can, in some implementations, combine the output segments 118 into an output tensor 120 using information specifying how the output segments 118 are mapped to corresponding elements of the output tensor 120. To do so, the tensor operation calculator 116 can allocate a region of memory to store the elements of the output tensor, as well as metadata for storing attributes (e.g., shape, size of dimensions, etc.) of the output tensor. The tensor operation calculator 116 can update the region of memory with combined elements according to the mapping between the output segments 118 and the output tensor 120.

In some implementations, the mapping between the output segments 118 and the output tensor 120 can be provided as part of the tensor operation or may be specified following calculation of the output segments 118. In some implementations, the tensor operation calculator 116 can store the output segments 118 calculated for a first tensor operation such that the output segments 118 can be reused as input segments 106 for a subsequent tensor operation. The subsequent tensor operation may be specified/identified by the data processing system 102 according to the techniques described herein. The output tensor 120 can be stored in memory of the data processing system 102 and/or provided to one or more applications or external computing devices that requested generation of the output tensor 120.

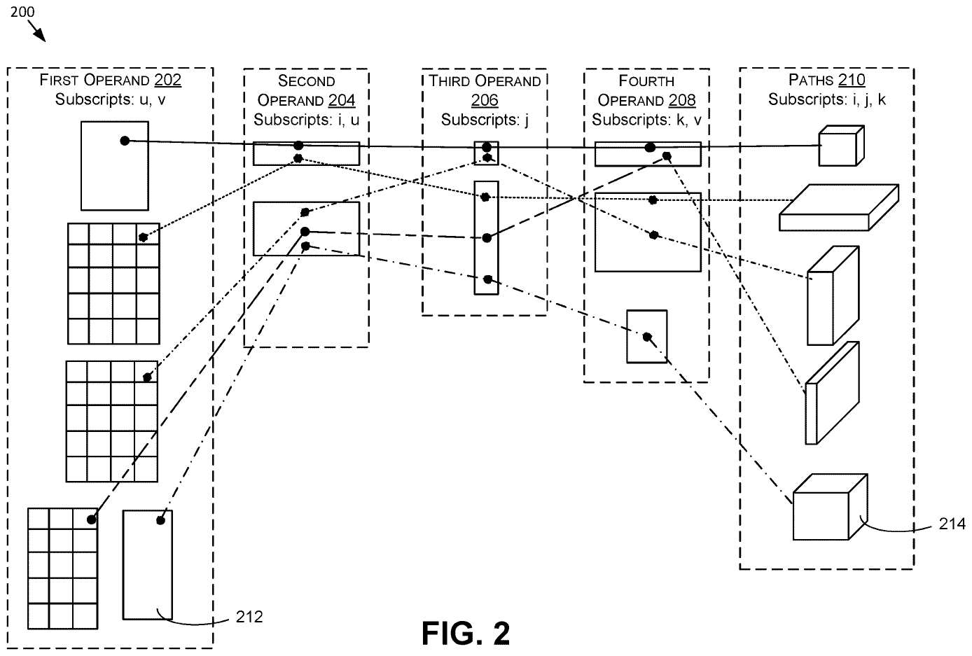

Referring to FIG. 2, depicted is an example diagram 200 showing computational paths for a segmented tensor product, in accordance with some embodiments of the present disclosure. In this example, four operands for a segmented tensor product operation are shown. The operands include a first operand 202, a second operand 204, a third operand 206, and a fourth operand 208. The operands 202-208 depicted in this example can be input operands (e.g., input operands 104) for a tensor operation. Each operand is shown as being associated with one or more segments 212 (e.g., input segments 106). The first operand 202 is associated with five segments. The second operand 204 is associated with two segments. The third operand 206 is associated with two segments. The fourth operand 208 is associated with three segments. The segments 212 of the operands are computed according to the processing paths 210, which are shown as including corresponding sets of coefficients 214. Each of the five processing paths 210 includes a segment associated with each operand. Regardless of the specific permutation of segments in a path, the outcome remains the same, as all paths ultimately converge to the same operation. In other words, each path, regardless of how the segments are ordered, leads to the same result due to the uniformity of the process across the segments.

As described herein, each operand 202-208 is shown as being associated with a set of subscripts. The first operand 202 is shown as having subscripts “u” and “v.” The second operand 204 is shown as having subscripts “i” and “u.” The third operand 206 is shown as having the subscript “j.” The fourth operand 208 is shown as having the subscripts “k” and “v.” The tensors storing the path coefficients 214 of the processing paths 210 are shown as having the subscripts “i,” “j,” and “k.” As described herein, the number of subscripts assigned to an operand (or coefficient) can be equal to the number of dimensions of the segments 212 and/or coefficients 214 of that operand. As such, the segments 212 of the first operand 202 are stored as two-dimensional tensors, the segments 212 of the second operand 204 are stored as two-dimensional tensors, the segments 212 of the third operand 206 are stored as one-dimensional tensors (e.g., as vectors), the segments 212 of the fourth operand 204 are stored as two-dimensional tensors, and the coefficients 214 corresponding to the paths 210 are stored as three-dimensional tensors.

Output segments (e.g., output segments 118) for the tensor operation can be generated by performing the tensor operations associated with each processing path 210. As shown, each processing path 210 can involve performing a tensor operation using a respective segment 212 from one or more of the input operands 202-208. In this example, each processing path 210 accesses a single input segment 212 from each input operand 202-208. Multiple input segments 212 may be used in multiple processing paths 210, enabling various caching approaches to improve computational performance of the tensor operation. In the illustrated example, the tensor operation may be specified according to the text string “uv,iu,j,kv+ijk.”

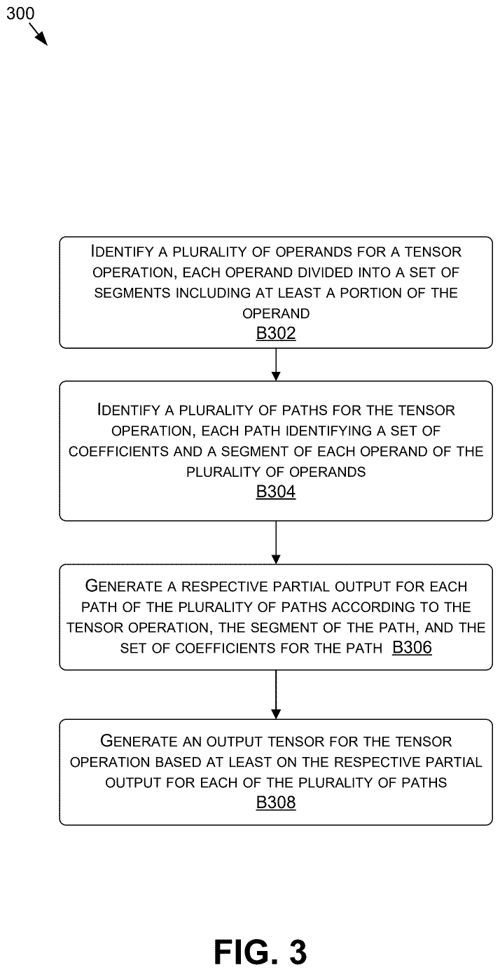

Now referring to FIG. 3, each block of method 300, described herein, includes a computing process that may be performed using any combination of hardware, firmware, and/or software. For instance, various functions may be carried out by one or more processors executing instructions stored in memory. The method may also be embodied as computer-usable instructions stored on computer storage media. The method may be provided by any number of circuits, logical devices, an application, a service or hosted service (standalone or in combination with another hosted service), or a plug-in to another product, to name a few. In addition, method 300 is described, by way of example, with respect to the system 100 of FIG. 1. However, this method may additionally or alternatively be executed by any one system, or any combination of systems, including, but not limited to, those described herein.

FIG. 3 is a flow diagram showing a method 300 for generating segmented tensor products using graphics processing units, in accordance with some embodiments of the present disclosure. The method 300, at block B302, includes identifying a plurality of operands (e.g., input operands 104) for a tensor operation. Each operand can be divided into a set of segments (e.g., input segments 106) that each include at least a portion of the operand. Segments of the input operands can be specified according to the tensor operation being performed, as described herein. Any number of operands can be identified for the tensor operation. Identifying the operands may include determining/assigning identifiers to each operand and corresponding segment identifiers to each segment of each operand. The operands/segments can be stored as dense and contiguous values in memory of the computing system executing the method 300 (e.g., the data processing system 102). Identifying the operands/segments may include performing any of the operations described herein in connection with the operand identifier 110 of FIG. 1.

The method 300, at block B304, includes identifying a plurality of paths (e.g., processing paths provided in path data 108, paths 210, etc.) for the tensor operation. The processing paths can each identify a set of coefficients (e.g., coefficients 214) and/or at least one segment of each operand identified at block B302. Identifying the processing paths can include accessing path information (e.g., path data 108) corresponding to the segments, which may specify operations (e.g., a text string) providing subscripts of operands that are to be processed via the processing path. Identifying the processing paths may include allocating memory to store each of the segments/coefficients. In some implementations, identifying the paths may include identifying/selecting one or more processing kernels (e.g., kernels 115) to perform various calculations identified in the processing paths. Identifying the processing paths may include performing any of the operations described in connection with the path enumerator 112 and/or the kernel selector 114 described in connection with FIG. 1.

The method 300, at block B306, includes generating a respective partial output for each path of the plurality of paths according to the tensor operation. This can include iterating through each of the processing paths identified in block B304 and executing the corresponding tensor operations to generate partial outputs (e.g., processing path outputs, output segment(s) 118, etc.). In some implementations, multiple partial outputs of multiple processing paths can be accumulated into one or more output segments. Generating the outputs of each processing path may include executing one or more respective kernels selected for a given processing path. In some implementations, caching can be performed to store portions of segments and/or other intermediate results such that the data can be accessed during processing of other paths. As described herein, tiling may be performed to efficiently store and process certain segments that having dimensions that exceed the size of cache memory. Generating the partial outputs for each processing segment may include performing any of the operations described in connection with the kernel selector 114 and/or the tensor operation calculator 116 of FIG. 1.

The method 300, at block B308, includes generating an output tensor for the tensor operation based at least on the respective partial output for each of the plurality of paths. In one example, an output tensor may be an output segment (e.g., an output segment 118). In such implementations, generating the output tensor can include accumulating multiple partial outputs from each processing path to generate the output segment. In some implementations, the output tensor can be a combination of multiple output segments (e.g., the output tensor 120). In such implementations, the output segments generated according to the techniques described herein can be combined to generate the output tensor according to a mapping between the output segments and corresponding elements of the output tensor. The mapping may be provided as part of the tensor operation or specified following the tensor operation, as described herein.

The systems and methods described herein may be used for a variety of purposes, by way of example and without limitation, for circuit layout definition, machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), light transport simulation (e.g., ray-tracing, path tracing, etc.), collaborative content creation for three-dimensional (3D) assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs) or one or more small language models (SLMs), systems for performing light transport simulation, systems for performing collaborative content creation for 3D assets, systems implemented at least partially using cloud computing resources, and/or other types of systems.

### Example Computing Device

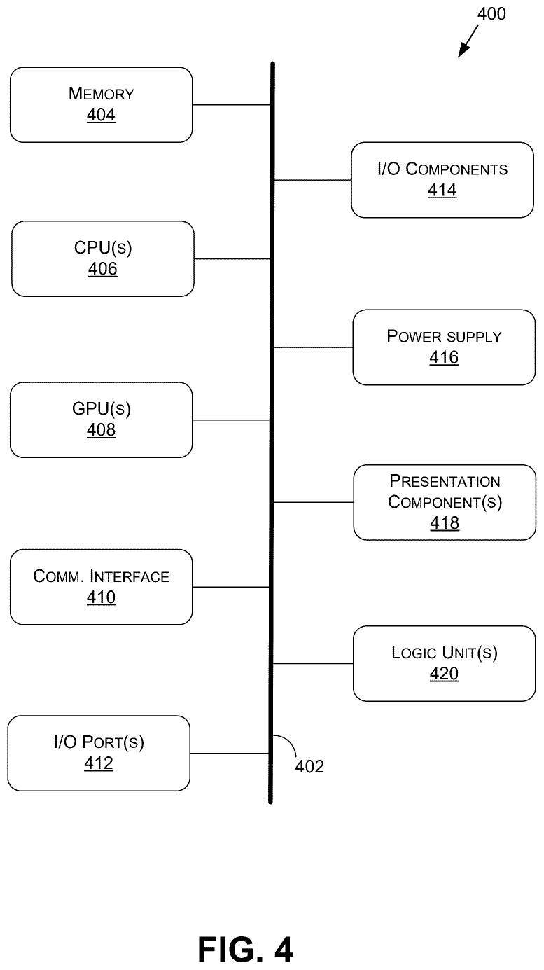

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, included wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may enable the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Example Data Center

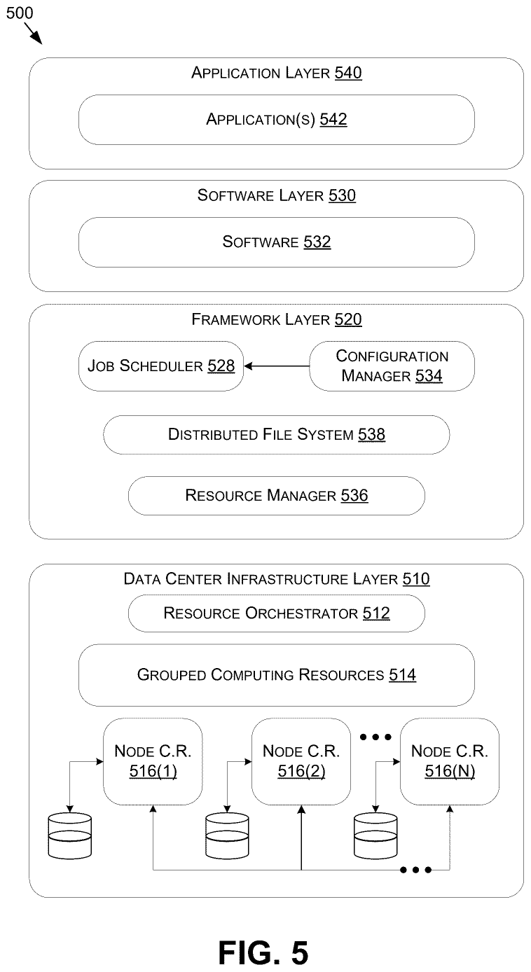

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516(N) may correspond to a server having one or more of the above-mentioned computing resources. In addition, in some embodiments, the node C.R.s 516(1)-5161(N) may include one or more virtual components, such as vGPUs, vCPUs, and/or the like, and/or one or more of the node C.R.s 516(1)-516(N) may correspond to a virtual machine (VM).

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may utilize distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train/update one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained/updated or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train/update or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more processing circuits to:
identify a plurality of operands for a tensor operation, each operand of the plurality of operands is associated with a set of segments;
identify a plurality of paths for the tensor operation, each path of the plurality of paths identifying a set of coefficients and a segment of each operand of the plurality of operands;
generate a respective partial output for each path of the plurality of paths according to segments of the path and the set of coefficients of the path; and
generate an output tensor for the tensor operation based at least on the respective partial output for each path of the plurality of paths.

2. The one or more processors of claim 1, wherein the plurality of operands is associated with a set of subscripts corresponding to a dimensionality of the set of segments.

3. The one or more processors of claim 2, wherein the one or more processing circuits are to:
determine the tensor operation from a string identifying the set of subscripts.

4. The one or more processors of claim 1, wherein the one or more processing circuits are to:
allocate a portion of cache memory of the one or more circuits to store one or more segments identified by at least two paths of the plurality of paths.

5. The one or more processors of claim 1, wherein the one or more processing circuits are to:
generate a first partial output for a first path of the plurality of paths using a first processing kernel; and
generate a second partial output for a second path of the plurality of paths using a second processing kernel.

6. The one or more processors of claim 5, wherein the one or more processing circuits are to:
select the first processing kernel based at least on one or more of a number of the plurality of operands or a dimensionality of at least one segment identified by the first path.

7. The one or more processors of claim 1, wherein the one or more processing circuits are to:
generate the set of segments for the plurality of operands, wherein the set of segments comprise a common shape.

8. The one or more processors of claim 1, wherein the one or more circuits are to:
identify a subset of the set of coefficients that has non-zero values; and
generate the respective partial output for the plurality of paths based at least on the subset.

9. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a small language model (SLM);
a system for performing generative AI operations using a video language model (VLM);
a system for performing generative AI operations using a multimodal language model;
a system for presenting at least one of virtual reality content, augmented reality content, or mixed reality content;
a system for generating synthetic data;
a system incorporating one or more virtual machines (VMs);
a system implemented at least partially in a data center; or
a system implemented at least partially using cloud computing resources.

10. A system, comprising:
one or more processors to:
receive a set of segments associated with a plurality of processing paths for a tensor operation;
select, based at least on the tensor operation, a first kernel for processing a first processing path of the plurality of processing paths and a second kernel for processing a second processing path of the plurality of processing paths; and
generate a set of output segments by executing the first kernel according to the first processing path and the second kernel according to the second processing path.

11. The system of claim 10, wherein the one or more processors are to:
generate the set of output segments further based on a first set of coefficients of the first processing path and a second set of coefficients of the second processing path.

12. The system of claim 10, wherein the one or more processors are to:
cache at least a portion of the set of segments in a shared memory.

13. The system of claim 12, wherein the tensor operation is an equivariant tensor operation, and wherein the one or more processors are to:
cache a first segment of the set of segments that is identified in both the first processing path and the second processing path; and
generate the set of output segments by accessing the shared memory using the first kernel and the second kernel.

14. The system of claim 10, wherein the one or more processors are to:
select the first kernel or the second kernel further based on dimensions of the set of segments.

15. The system of claim 10, wherein the one or more processors are to:
select the first kernel or the second kernel further based on a number of operands for the tensor operation.

16. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for performing generative AI operations using a small language model (SLM);
a system for performing generative AI operations using a video language model (VLM);
a system for performing generative AI operations using a multimodal language model;
a system for presenting at least one of virtual reality content, augmented reality content, or mixed reality content;
a system for generating synthetic data;
a system incorporating one or more virtual machines (VMs);
a system implemented at least partially in a data center; or
a system implemented at least partially using cloud computing resources.

17. A method, comprising:
identifying a plurality of operands and a plurality of sets of segments for a tensor operation, each set of the plurality of sets of segments corresponds with an operand of the plurality of operands;
identifying a plurality of paths each identifying a set of coefficients and a segment from each set of the plurality of sets of segments;
selecting a plurality of kernels based on one or more of the plurality of operands or the plurality of sets of segments;
executing the plurality of kernels to generate an output tensor for the tensor operation.

18. The method of claim 17, wherein the plurality of operands is associated with a set of subscripts corresponding to a dimensionality of the set of segments.

19. The method of claim 18, further comprising:
determining the tensor operation from a string identifying the set of subscripts.

20. The method of claim 17, further comprising:
allocating a portion of cache memory to store one or more segments identified by at least two paths of the plurality of paths.
